(19) United States
(12) Patent Application Publication
(10) Pub. No.: US 2009/0159849 A1
(43) Pub. Date: Jun. 25, 2009

(54) FLUORESCENT AND METHOD FOR PRODUCING THE SAME

(75) Inventors: Masato Uehara, Saga (JP); Hiroyuki Nakamura, Saga (JP); Hideaki Maeda, Saga (JP); Masaya Miyazaki, Saga (JP); Yoshiko Yamaguchi, Saga (JP); Kenichi Yamashita, Saga (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: National Institute of Advanced Industrial Science and Technology, Chiyoda-ku, Tokyo (JP)

(21) Appl. No.: 12/094,886

(22) PCT Filed: Nov. 17, 2006
(86) PCT No.: PCT/JP2006/322989

§ 371 Date: May 23, 2008

(30) Foreign Application Priority Data
Nov. 24, 2005 (JP) 2005-339526
Nov. 9, 2006 (JP) 2006-304592

(51) Int. Cl. C09K 11/54; C09K 11/08; C09K 11/56; C09K 11/88

(52) U.S. Cl. 252/301.6 S; 252/301.4 R; 252/301.4 S; 252/301.6 R

(57) ABSTRACT

To provide a fluorescent having low toxicity and high quantum yield, and a method for producing the same. The fluorescent is a compound comprising each one of I, III and VI group elements having a chalcopyrite structure, has a particle diameter of 0.5 to 20.0 nm and a quantum yield of at least 3% but not more than 30% at room temperature. The fluorescent is produced by: mixing a first solution (solution A), which is prepared by dissolving and mixing copper (I) salt and indium (III) salt in a solution added with a complexing agent coordinating copper (I) and indium (III), with a second solution (solution C) in which a sulfur compound is dissolved; ripening the mixed solution for a predetermined amount of time as a pretreatment; heat-treating the ripened solution under predetermined heat conditions; mixing the ripened solution with the second solution (solution C); and heating thus obtained mixed solution under predetermined synthesis conditions. In addition, a product produced by this production method is subjected to compositing treatment with ZnSe, ZnS or the like to improve the quantum yield.

### TECHNICAL FIELD

The present invention relates to a fluorescent and a method for producing the same. More specifically, the present invention relates to a fluorescent composed of a semiconductor nanoparticle for use in modification/dyeing for a biologically-relevant substance, illumination, display and the like, and to a method for producing the fluorescent.

### BACKGROUND

Quantum size effects are produced when a semiconductor is reduced in size to the nanometer order, and consequently the band gap energy increases accompanying a reduction in the number of atoms. A semiconductor fluorescent nanoparticle made of a nanometer semiconductor generates fluorescence equivalent to the band gap energy of the semiconductor. In CdSe nanoparticles of [II-VI type semiconductors], the fluorescent color can be freely adjusted within the range of 500 to 700 nm by adjusting the particle diameter of the nanoparticles, and the nanoparticles have the high fluorescent property thereof (see Patent Document 1, for example).

The II-VI type semiconductors typified by a CdSe nanoparticle are inorganic semiconductors, and the possibility of application as fluorescent tags for biochemical analyses, fluorescence material for illumination and displays and the like has been suggested, due to being more stable than organic pigments. However, cadmium (Cd), mercury (Hg), lead (Pb) and other heavy metals contained in the II-VI type semiconductors involve a considerable environmental risk during production and use.

Recently, Restriction of Hazardous Substances (RoHS) has been issued in Europe for restricting the use of six hazardous substances which are harmful to the global environment and human health in electrical/electronic equipment, the substances being lead (Pb), cadmium (Cd), hexavalent chrome (Cr6+), mercury (Hg), polybromobiphenyl (PBB), and polybromodiphenylether (PBDE). As in the case of [such issuance of] the RoHS, the use of these heavy metals is restricted in many other cases.

Of such II-VI type semiconductors, ZnS, ZnSe or other compound semiconductor that does not contain these heavy metals has a large band gap and thus produces a fluorescence of short wavelength only, hence fluorescence wavelengths cannot be controlled in a wide range from visible light to near-infrared light. In addition, a nanoparticle that generates fluorescence of visible light at room temperature are developed for III-V type semiconductors and IV type semiconductors such as silicon and germanium. Because the III-V type semiconductors and IV type semiconductors such as silicon do not contain the abovementioned restricted heavy metals, [these semiconductors] are relatively less toxic and generate fluorescence of a visible-light region.

However, it is difficult to develop the III-V and IV type semiconductors in an industrial field requiring low cost [production], due to the high covalent bonding properties [of these semiconductors] and the troublesome processes required in the production thereof. Furthermore, a chalcopyrite compound is a semiconductor compound, and the use thereof as a solar cell light absorber or the like has been suggested. As with the II-VI type semiconductors, the chalcopyrite compound semiconductor is a direct transition semiconductor. The chalcopyrite compound semiconductor is expected to be used in the same manner as the nanoparticles of the II-VI type semiconductors as long as it is possible to obtain a quantum yield as high as that of the II-VI type semiconductors.

Therefore, the inventors of the present invention have conducted keen study in the aim of creating a new semiconductor fluorescent nanoparticle composed of a low toxic element. Through the study, [the inventors of the present invention] focused their attention especially on CuInS₂ as a target material, which is a compound with a chalcopyrite structure, whose property is similar to that of CdSe, composited [this compound] with II-VI type compound such as ZnS, evaluated the fluorescent property, and contrived and proposed an invention that relates to a fluorescent having a fluorescent quantum yield of no more than 10% (Patent Document 2).

However, [as a method for synthesizing] a chalcopyrite nanoparticle itself that is not composited with the II-VI type semiconductors such as ZnS, there is only an example of a synthetic method using a monomolecular raw material, which cannot be synthesized by a simple synthetic method (Nonpatent Document 1). A chalcopyrite-type nanoparticle of CuInS₂ having a fluorescent quantum yield of approximately 4% and an outer particle diameter of approximately 2 to 5 nm can be synthesized using the monomolecular raw material. However, because synthesis of the monomolecular raw material itself is complicated, a simpler synthetic method is industrially desired.

On the other hand, the chalcopyrite-type nanoparticle can be synthesized by a method of dissolving metallic salt, which is a raw material, into a solution containing a complex, but the fluorescent quantum yield of the nanoparticle obtained by this synthetic [method] is no more than 0.1%, which is difficult to be applied to practical use. Therefore, although it is possible to synthesize a CuInS₂ nanoparticle, a material whose quantum yield exceeds 10% so as to be applied in a wide range of application has not yet been obtained. This is because it is extremely difficult to control defects of the chalcopyrite compound. Specifically, when an exciton excited by excitation light is captured by a defect of the material, a part of [the exciton] returns to the ground state without emitting light (called “radiationless transition”).

Therefore, a problem in reduction of quantum yield occurs in a compound having many defects. From this standpoint, in order to prevent the radiationless transition caused by defects, it is necessary to improve a process for synthesizing the compounds to synthesize a compound having as less defects as possible. Moreover, it is a known fact that coating II-VI type semiconductors, such as CdSe, with a semiconductor (ZnS, for example) having a larger band gap than the core semiconductor [of the II-VI type semiconductors] effectively prevents the exciton excited by the excitation light from reaching a particle surface having many defects and from performing radiationless transition due to the defects of the surface, so that the quantum yield thereof can be improved (Nonpatent Document 2).

[Patent Document 1] Published Japanese Translation No. 2003-524147 of the PCT International Publication

[Patent Document 2] PCT/JP2005/013185

[Nonpatent Document 1] B. O. Dabbousi, J. Rodriguez-Viejo, F. V. Mikulec, J. R. Heine, H. Mattoussi, R. Ober, K. F. Jensen, and M. G. Bawendi, J. Phys. Chem. B 1997, Vol. 101, p 9463-9475

[Nonpatent Document 2] S. L. Castro, S. G. Bailey, R. P. Raffaelle, K. K. Banger, and A. F. Hepp, J. Phys. Chem. B 2004, Vol. 108, p 12429-12435

### DISCLOSURE OF THE INVENTION

The present invention has been contrived in view of the background described above, and achieves the following objects.

An object of the present invention is to provide a chalcopyrite semiconductor nanoparticle fluorescent having high quantum yield and low toxicity, and a method for producing [the fluorescent].

Another object of the present invention is to provide a compound having an outer particle diameter of 1 to 10 nm and a chalcopyrite structure, a nanoparticle fluorescent in the form of a solid solution having high quantum yield and an outer particle diameter of 1 to 20 nm, which is prepared by solid-solving II-VI type compound semiconductors or I-III-VI type compound semiconductors in the abovementioned compound, and a method for producing [this fluorescent].

Yet another object of the present invention is to provide a fluorescent having high quantum yield, which is composed of a composite particle obtained by coating the surface of a nanoparticle composed of a compound having a chalcopyrite structure with a semiconductor having a band gap wider than a band gap of this compound, and to provide a method for producing [this fluorescent].

A yet further object of the present invention is to provide a fluorescent having high quantum yield, which is composed of a composite particle obtained by coating the surface of a solid solution-type composite nanoparticle composed of a compound having a chalcopyrite structure and II-VI type or I-III-VI type compound semiconductors with a semiconductor having a band gap wider than band gaps of these compounds, and to provide a method for producing [this fluorescent].

In order to achieve the above objects, the present invention employs the following means.

The inventors of the present invention have improved a synthetic process for completing a metal, which is a raw material, with a complexing agent and thereafter heating or ripening [the metal] at room temperature, and have ended up inventing a compound nanoparticle having a fluorescent quantum yield of at least 3% but not more than 20% and a chalcopyrite-type structure. This compound nanoparticle has a fluorescent quantum yield of at least 10%, which has never been obtained before. The fluorescent quantum yield is the percentage of fluorescence emitted by a fluorescent excited by excitation light, in relation to the excitation light.

Throughout the present specification, “fluorescent quantum yield” is sometimes simply described as “quantum yield.” A method for measuring the fluorescent quantum yield in the present invention is as follows. First, the absorbency and fluorescence intensity of rhodamine B known to have a quantum yield of 73% and of a product of the present invention are measured, the results of the measurement are compared with each other, and the quantum yield of the product of the present invention is estimated.

“Ripening” above means heating [the metal] within the raw material at a temperature lower than the temperature for heating a reaction solution, for a predetermined amount of time, in order to react the metal with chalcogenite (hereinafter, “heating at low temperature” [or “low-temperature heating”] and “ripening” will be used to mean the same thing). “Heating temperature” here means the temperature at which the reaction solution reacts and eventually the nanoparticle is synthesized. Through this ripening [process], a cluster for nanoparticle formation is formed from the reaction solution, and thereby a nanoparticle is formed easily in a subsequent heating [process].

Low-temperature heating is performed at a temperature lower than the temperature used in the subsequent heating [process] For example, when the heating temperature is 100° C. to 300° C., the temperature for low-temperature heating is between 0° C. and 100° C. The length of ripening time or period takes several seconds to several hours, or a total of several tens of days. For example, leaving [the raw material solution] for 24 hours at a room temperature of 25° C. is in the range of this ripening [time period]. Also, leaving [the raw material solution] for 30 days at a room temperature of 25° C., for example, also is within the range of this ripening [time period].

Furthermore, a compound that is obtained by using this method had high quantum yield. Specifically, in a compound that is obtained by solid-solving other chalcopyrite type compound or II and VI group semiconductor compounds in the abovementioned chalcopyrite type compound (called “solid solution compound” hereinafter), the quantum yield was as high as 30%. This is a high quantum yield which has never been obtained before. Moreover, as with the conventional compounds, it has been found that the wavelength of this compound can be controlled by the composition and particle diameter [of this compound].

[Fluorescent]

The fluorescent of the present invention is composed of a first compound comprising a I, III and VI group compound with a chalcopyrite structure, such as CuInS₂, CuGaS₂ or AgInS₂ (a compound comprising Cu or Ag as the I group element, In, Ga or Al as the III group element, and O, S, Se or Te as the VI group element), wherein the first compound is a particle having a quantum yield of at least 3% but not more than 20%, or preferably at least 10% but not more than 20%, and an outer particle diameter of 0.5 to 20.0 nm.

Moreover, the fluorescent of the present invention is preferably a nanoparticle of a solid solution compound which is obtained by solid-solving the abovementioned first compound and at least one compound of I, III and VI group compounds with chalcopyrite structures, which is a compound other than the first compound, and II and VI group compounds. The I-III-VI group compounds with a chalcopyrite structure, which is a compound other than the first compound, is preferably, for example, CuInS₂, AgInS₂, CuGaS₂, AgGaS₂, CuAlS₂, AgAlS₂, CuInSe₂, AgInSe₂, CuGaSe₂, AgGaSe₂, CuAlSe₂, AgAlSe₂, CuInTe₂, AgInTe₂, CuAlO₂, AgAlO₂, or the like.

The II-VI group compounds are preferably, for example, ZnO, ZnS, ZnSe, ZnTe, or the like. Furthermore, the fluorescent of the present invention is preferably a nanoparticle of the abovementioned solid solution compound in which the elements thereof are substituted with other elements of the same group, such as Cu, Ag, Al, Ga, In, O, S, Se, Te, Na, Li, and K. In addition, the fluorescent of the present invention is preferably composed of a composite particle which is obtained by coating on the abovementioned first compound or the abovementioned solid solution compound with one or more of the II and VI group compounds (e.g., ZnO, ZnS, ZnSe, ZnTe or the like) and the chalcopyrite-type compound, and is preferably a nanoparticle having a quantum yield of at least 66 but not more than 30%, or preferably at least 6% but not more than 25%.

Note that the outer particle diameter of the abovementioned first compound, the solid solution of the first compound, or the abovementioned composite particle or composite compound is 1.0 to 20.0 nm. Note that II and VI group semiconductors, such as CdS, CdSe, CdTe, HgS, HgSe, HgTe, PbS, PbSe, and PbTe, can be used as the II and VI group semiconductors to be solid-solved. In this case, such [II and VI group semiconductors] are used within legal restraints. In addition, as a compound for forming a solid solution composite particle by solid-solving the abovementioned first compound, III and V group semiconductors, such as InP, InN, InAs, GaP, GaN, GaAs, AlN, AlP, and AlAs, can be used. Also, it is preferable that a desired band gap be formed by the solid solution or its solid composition.

In this case, in such a composite compound, its band gap and fluorescent wavelength can be controlled by controlling the type of element to be solid-solved in the first compound and the solid-solving amount [of the element]. Furthermore, the first compound of the present invention and the composite compound obtained by solid-solving other element in the first compound are each obtained as a composite particle by forming a composite structure, which is obtained by coating the surface of the particle [of each of these compounds] with a second compound semiconductor having a band gap wider than those of these compounds, whereby a nanoparticle having a high quantum yield of 10% or above can be obtained.

The composite particle is a compound in which the first compound is composited with, within one particle, [the II and VI group semiconductors such as] ZnO, ZnS, ZnSe, and ZnTe, or, according to use application, one or a plurality of the II and VI group semiconductors such as CdS, CdSe, CdTe, HgS, HgSe, HgTe, PbS, PbSe, and PbTe, the III and V group semiconductors such as InP, InN, InAs, GaP, GaN, GaAs, AlN, AlP, and AlAs, or other chalcopyrite compound composed of I, III and VI group elements other than the first compound (these [compounds] are generically called “second compounds”), and it is preferable that [the composite particle] be a core-shell composite particle which is constructed by coating the first compound with the second compound.

In this case, it is preferable that the lattice mismatch ratio indicating the mismatch in lattice constants between the first compound or its solid solution, which is the core, and the second compound, which is the shell, be not more than 10%, or preferably not more than 5%. When the lattice mismatch ratio is comparatively large, it is possible to form a composition gradient type composite particle in which the second compound gradiently changes the composition ratio [between the first and second compounds] while increasing the composition ratio from the surface of the surface of the first compound, which is the core, toward the surface of the particle. In this case, the stress between the first compound and the coating layer is relaxed by the slow composition change, hence defects due to the stress can be prevented and higher quantum yield can be achieved.

Moreover, [the particle] may be coated with two or more layers of two or more second compounds in accordance with the lattice mismatch ratio, band gap, energy positions of a conduction band and of a valence band, or the like. This is effective because, when the lattice mismatch ratio between the coating layer of the outermost shell and the chalcopyrite compound is large, the stress generated at the interface can be reduced. Even in the case of a particle coated with one layer of the second compound or a particle coated with two or more layers, it is preferable that the lattice mismatch ratio between the adjacent compounds be not more than 10, preferably not more than 5%, and it is also preferable that the second compound be a compound having a band gap wider than that of the first compound.

It is preferable that the outer diameter of the composite particle be 2 to 20 nm. The first compound composing the composite compound is preferably composed of the elements of copper (Cu), indium (In) and sulfur (S), while the second compound is preferably composed of the elements of silver (Ag), indium (In) and sulfur (S). In this case, the composition ratio of copper (Cu) to silver (Ag) is preferably X:1−X, where X is 0.01 to 0.99.

Furthermore, the first compound composing the composite compound is preferably composed of the elements of copper (Cu), indium (In) and sulfur (S), while the second compound is preferably composed of the elements of copper (Cu), gallium (Ga) and sulfur (S). In this case, the composition ratio of indium (In) to gallium (Ga) is preferably X:1−X, where X is 0.01 to 0.99.

Moreover, the first compound composing the composite compound is preferably composed of the elements of copper (Cu), indium (In) and sulfur (S), while the second compound is preferably composed of zinc sulfide (ZnS). In this case, the composition ratio of copper (Cu) to zinc (Zn) is preferably X:1−X, where X is 0.01 to 0.99.

In addition, the first compound composing the composite compound is preferably composed of the elements of copper (Cu), indium (In) and sulfur (S), while the second compound is preferably composed of zinc selenide (ZnSe). In this case, the composition ratio of copper (Cu) to zinc (Zn) is X:1−X, where X is 0.01 to 0.99.

The band gap of the first compound is determined by the particle diameter thereof and the elements composing the chalcopyrite type compound [of the same], but it is preferable that the band gap be in the range of 1.0 to 3.5 eV.

Furthermore, the quantum yield obtained when the first compound is excited by excitation light and thereby emits a light wave preferably exceeds 10.0% at room temperature, and is preferably not more than 30.0%. It is preferable that fluorescence emitted by the first compound be a light wave having a wavelength of 500 to 950 nm. Moreover, it is preferable that fluorescence emitted by the solid solution of the first compound be a light wave having a wavelength within the range of 500 to 850 nm.

[Method for Producing Fluorescent]

The method for producing a fluorescent according to the present invention is a method for producing a fluorescent, which comprises [the steps of] mixing a first solution with a second solution, and heat-treating [the mixed solution] under predetermined heat conditions. Also, the present invention provides a fluorescent produced by this producing method. The first solution is a solution which is prepared by dissolving and mixing raw material salts of a plurality of types of elements composing a compound having a chalcopyrite structure in a solution added with a complexing agent coordinating the plurality of types of elements. The second solution is a solution prepared by dissolving a chalcogenite compound.

The chalcogenite compound preferably forms a preferred chalcopyrite compound precursor by being heated or ripened in the presence of a metal ion. [As the chalcogenite compound], a salt of dithiocarbamic acid such as dimethyldithiocarbamic acid, diethyldithiocarbamic acid and dihexyldithyiocarbamic acid, a salt of xanthic acid such as hexadecyl xanthate and dodecyl xanthate, a salt of trithiocarboxylic acid such as hexadecyl trithiocarboxylic acid and dodecyl trithiocarboxylic acid, zinc of dithiophosphoric acid such as hexadecyl dithiophosphoric acid and dodecyl dithiophosphoric acid, a metallic salt having [a mixture of] cadmium, magnesium, manganese, nickel, copper, lead or the like with sulfur or the like, thioacetamide, alkylthiol, thiourea and derivatives thereof, or a compound which generates chalcogen such as sulfur, selenium and tellurium by heating and thereby decomposing trioctylphosphine selenide, trioctyl phosphine telluride or the like can be used.

The complexing agent preferably coordinates to the plurality of types of elements composing the compound having a chalcopyrite structure. [As the complexing agent], amine compounds such as oleylamine, octylamine, dodecylamine, hexadecylamine, tributylamine and octadecyldimethylamine, carboxylic acid compounds such as stearic acid, oleic acid and lauric acid, and thiol compounds such as dodecanethiol and octanethiol can be used.

It is preferable that, after mixing of all or some of these raw material solutions, the mixed solution be ripened or heated for the purpose of pretreatment. A preferred form of complexation is performed by the reaction of the mixed solution during the pretreatment, whereby a compound nanoparticle having higher fluorescent quantum yield can be formed. After the pretreatment, the mixed solution is preferably heated under predetermined heat conditions.

Under the predetermined pretreatment conditions, it is preferable that the first solution and the second solution be mixed and subjected to heat treatment at a temperature of 0° C. to 100° C. Also, under the predetermined pretreatment conditions, it is preferable that the first solution and the second solution be mixed and subjected to ripening treatment for a duration of at least one second to not more than 30 days. Under the predetermined heat conditions, it is preferable that [the mixed solution] be subjected to heat treatment at temperature within the range of 100° C. to 300° C. after the pretreatment.

Under the predetermined heat conditions, it is preferable that [the mixed solution] be subjected to heat treatment for one second to 30 hours after the pretreatment. Under the predetermined heat conditions, it is preferable that the first solution and the second solution be mixed, heated, and reacted in a microreactor having a flow channel of 50 μm to 5 mm. Moreover, a sulfur compound is preferably a thioacetamide.

Furthermore, it is preferable that the first solution be a solution which is prepared by dissolving and mixing copper (I) or copper (II) salt with indium (III) salt at a concentration of 0.01 to 0.1 mol/L in a solution added with a complexing agent coordinating copper (I) and indium (III). It is preferable that [the first solution] be produced from raw materials of copper (Cu), indium (In) and sulfur (S) at a composition ratio (feed ratio) of A:B:2, with A being 0.5 to 10.0 and B being 0.5 to 10.0.

Moreover, it is preferable that the first solution be a solution which is prepared by dissolving and mixing silver (I) salt and indium (III) salt at a concentration of 0.01 to 0.1 mol/L in a solution added with a complexing agent coordinating silver (I) and indium (III). It is preferable that [the first solution] be produced from raw materials of silver (Ag), indium (In) and sulfur (S) at a composition ratio (feed ratio) of A:B:2, with A being 0.5 to 10.0 and B being 0.5 to 10.0.

In addition, it is preferable that the first solution is a solution which is prepared by dissolving and mixing copper (I) or copper (II) salt with gallium (III) salt at a concentration of 0.01 to 0.1 mol/L in a solution added with a complexing agent coordinating copper (I) and indium (III). It is preferable that [the first solution] be produced from raw materials of copper (Cu), gallium (Ga), and sulfur (S) at a composition ratio (feed ratio) of A:B:2, with A being 0.5 to 10.0 and B being 0.5 to 10.0.

The compound with a chalcopyrite structure, which is the first compound and composed of I, III and VI group elements, may be known [compound], but it is particularly preferable that at least one type of element be selected from each group of the I group elements of Cu and Ag, from the III group elements of In, Ga and Al, and from the VI group elements of S, Se and Te respectively.

The mixing ratio between the chalcopyrite compound and a compound to be composited can be changed freely to the extent that a solid solution or a composite structure is formed, but it is preferred to composite a compound that is composited at a molar ratio of 0.01 to 10 times, preferably 0.1 to 5 times relative to one element of the chalcopyrite compound which is the first compound.

According to the present invention, the following effects can be accomplished.

The fluorescent of the present invention does not contain any heavy metal elements, such as mercury (Hg), lead (Pb) and cadmium (Cd), which are subject to control as hazardous substances harmful to the environment and human body, and is a compound composed of the I, III and VI group elements having a chalcopyrite structure, or a composite particle or composite compound containing this compound. Because this composite particle or composite compound contain groups I, III and VI chalcopyrite compounds or groups II and VI elements, it does not contain Hg, Pb, Cd and other heavy metal elements that are subject to control.

Furthermore, the quantum yield of a product is improved more than ever before by performing pretreatment such as ripening the reaction solution for a predetermined amount of time. Therefore, the present invention can provide a fluorescent which is a semiconductor nanoparticle having low toxicity and high quantum yield.

Moreover, a product exhibiting fluorescence [within the range] from visible light to near-infrared light can be achieved by adjusting the elemental composition of the fluorescent and the contents of the elements. In addition, a fluorescence wavelength [in the range] from visible light to near-infrared light can be controlled by changing the temperature and time of heating the reaction solution.

The present invention can improve high quantum yield and thereby improve the quantum yield up to a maximum of approximately 28% by coating the chalcopyrite compound and its solid solution with a compound semiconductor having a band gap wider than a band gap of a core semiconductor.

### BRIEF DESCRIPTION OF THE DRAWINGS

FIG. 1 shows a fluorescence intensity graph of fluorescents of Example 1.

FIG. 2 is a graph showing fluorescence intensities of fluorescents in Example 1 which are generated in a plurality of heating times.

FIG. 3 is a graph showing absorbencies of the fluorescents shown in FIG. 2.

FIG. 4 shows fluorescence intensities [of fluorescents] which are generated at a plurality of heating temperatures.

FIG. 5 shows the spectra of light wave emitted from the fluorescents at a plurality of excitation wavelengths.

FIG. 6 shows a fluorescence intensity graph for the case in which [the fluorescents] are generated based on a plurality of raw material compositions.

FIG. 7 is the results of XRD of the products of Example 1.

FIG. 8 shows a fluorescence intensity graph for the case in which of fluorescents of Example 2 are generated at a heating temperature of 200° C.

FIG. 9 shows a fluorescence intensity graph for the case in which of fluorescents of Example 3 are generated at a heating temperature of 200° C.

FIG. 10 is a graph showing absorbencies of the fluorescents shown in FIG. 9.

FIG. 11 is a graph showing maximum values of absorption wavelengths and maximum values of fluorescence wavelengths of the products of Example 3.

FIG. 12 is a graph showing fluorescence intensities of fluorescents of Example 4 which are generated in a plurality of heating times.

FIG. 13 is a graph showing fluorescence intensities of fluorescents of Example 5 which are generated in a plurality of heating times.

FIG. 14 is a graph showing fluorescence intensities of fluorescents of Example 6 which are generated in a plurality of heating times.

FIG. 15 is a graph showing fluorescence intensities of fluorescents of Example 7 which are generated in a plurality of heating times.

FIG. 16 is a graph showing fluorescence intensities of fluorescents of Example 7 which are generated based on a plurality of composition ratios.

FIG. 17 is a graph showing fluorescence intensities of fluorescents of Example 8 which are generated in a plurality of heating times.

FIG. 18 is a graph showing fluorescence intensities of fluorescents of Example 8 which are generated based on a plurality of composition ratios.

FIG. 19 is a graph showing fluorescence spectra of fluorescents of Example 9.

### BEST MODE FOR CARRYING OUT THE INVENTION

Embodiments of the present invention will now be described hereinafter in detail using examples. The embodiments of the present invention are not limited to the following examples, and thus [examples] that exhibit the same effects by transforming the solutions and compounds to be used also fall within the scope of the present invention.

### Example 1

### CIS

Here, Example 1 for producing the fluorescent of the present invention will now be described. Reaction solutions were all prepared under argon atmosphere using argon gas. Copper iodide (I) and indium iodide (III) were dissolved at a concentration of 0.017 mol/L in oleylamine which is a complexing agent, to obtain a solution A. Oleylamine is a basic organic solvent and a coordinating solvent, and was used as a complexing agent for a metal ion and a stabilizing agent by coordinating the surface of a generated particle to prevent particle aggregation (this is the same for the following examples).

Thioacetamide was dissolved at a concentration of 0.034 mol/L in trioctyl phosphine to obtain a solution C. A reaction solution with a mixture of 18 mL of the solution A and 18 mL of the solution C was basically ripened for 24 hours at a temperature of 25° C. under argon atmosphere. Thereafter, the reaction solution was heated and reacted for 3 seconds to 10 minutes at a temperature of 160° C. to 280° C. Note that heating for 3 seconds to 2 minutes was performed using a microreactor having an inner diameter of 200 μm. Thus obtained products were diluted with toluene, and absorbency/fluorescence spectrum [of each product] was measured. The results of the measurement are shown in the form of a graph.

(Ripening Effects)

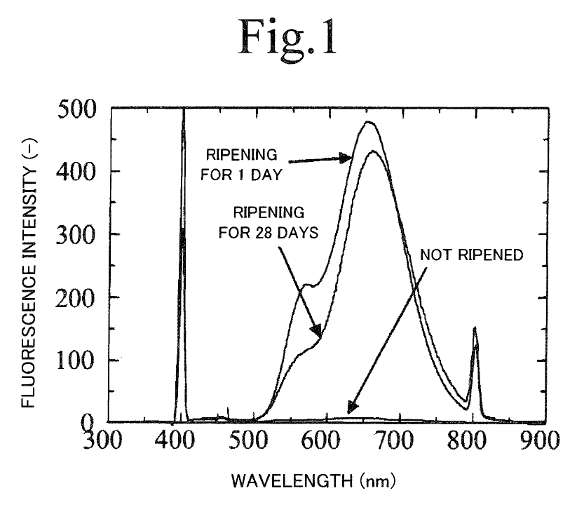

The graph of FIG. 1 shows the results of heating the reaction solution having a mixture of the solution A and the solution C at a temperature of 200° C. to generate fluorescents. The vertical axis of the graph of FIG. 1 represents fluorescence intensity and the horizontal axis represents wavelength. The fluorescence intensity is [represented as] any relative values (same hereinafter). The unit of wavelength is nanometer (same hereinafter). This graph shows the results of generating the fluorescents from reaction solutions that were ripened for 24 hours and for 28 days at a temperature of 25° C. before reaction and from a reaction solution that was not.

In this graph, the two graphs showing large fluorescence intensities show fluorescence intensities of the fluorescents that were generated from the reaction solutions ripened before being heated. In this graph, the graph showing a small fluorescence intensity shows fluorescence intensity of the fluorescent generated from the reaction solution that was not ripened. It is understood from this graph that the fluorescence intensities of the fluorescents that were generated from the reaction solutions ripened before being heated have increased more significantly than the fluorescence intensity of the fluorescent generated from the reaction solution that was not ripened.

(Heating Time)

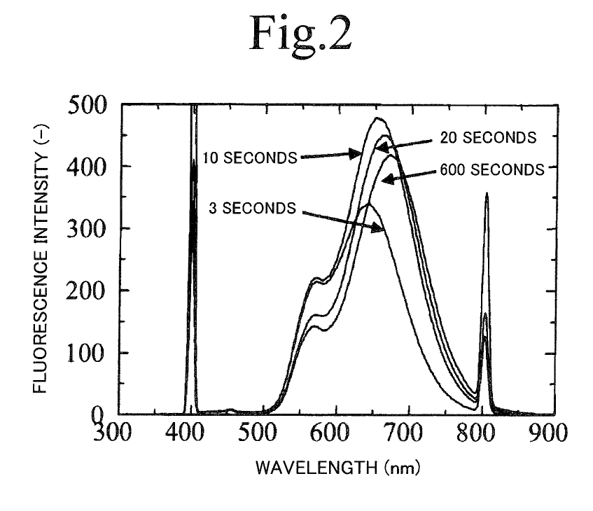

The graph of FIG. 2 shows the results of generating fluorescents by heating, for a plurality of times, the reaction solution that was ripened for 24 hours at a temperature of 25° C. under argon atmosphere. FIG. 2 shows the relationship between the intensity and spectrum of each of the light waves emitted by the generated fluorescents. The graphs [show] the cases where the heating times were 3 seconds, 10 seconds, 20 seconds, and 600 seconds, respectively. The heating temperature was 200° C. The vertical axis of FIG. 2 represents fluorescence intensity and the horizontal axis represents wavelength.

(Quantum Yield, Exceeding 10%)

Table 1 shows quantum yields, each of which represents a ratio of photons emitted by fluorescence to the number of photons of excitation light absorbed by each of the fluorescents shown in the graphs in FIG. 2. The quantum yields are each obtained by dividing the number of photons of fluorescence by the number of photons absorbed by the particle. This value is obtained based on a relative comparison between the absorbency (the definition of which will be described hereinafter) and fluorescence intensity of rhodamine B or other reference material, which has a known quantum yield.

The rhodamine B used for measuring the quantum yields has a quantum yield of 73% at an excitation of 365 nm. Fluorescent property was measured using Spectrophotofluorometer FP6600 of JASCO corporation (Address: Hachioji-shi, Tokyo) (this is the same for the other following examples). All of the quantum yields shown in Table 1 are values exceeding 10%.

TABLE 1

| Heating Time (seconds) | Quantum Yield (%) |
|---|---|
| 3 | 13.2 |
| 10 | 14.5 |
| 20 | 12.1 |
| 600 | 10.3 |

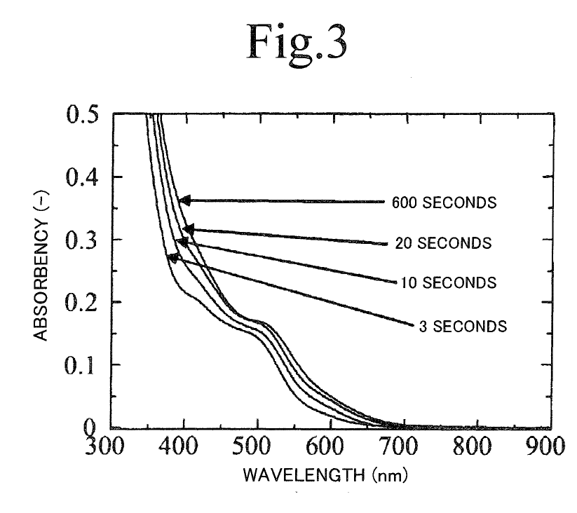

FIG. 3 shows absorbencies each showing the amount of excitation light absorbed by each of the fluorescents shown in the graphs in FIG. 2. The abovementioned rhodamine B was used as a reference material for measuring the absorbencies. The absorbencies were measured using Ultraviolet-visible Spectrophotometer V-570 of JASCO corporation (Address: Hachioji-shi, Tokyo) (this is the same for the other following examples). The vertical axis of the graph of FIG. 3 represents absorbency as a relative value and the horizontal axis represents wavelength. The absorbency is a physical quantity defined as follows. An absorbency A is defined as follows:

A=−log(I/I₀) (Eq. 1)

where I₀ is the intensity of incident light, and I is the intensity of transmitted light.

(Heating Temperature)

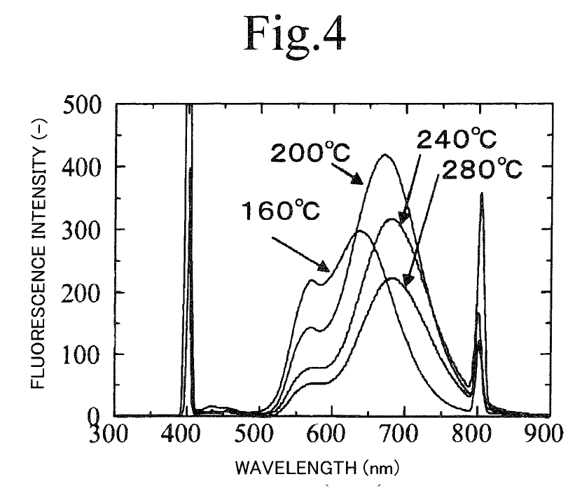

FIG. 4 shows the results of generating fluorescents at a plurality of heating temperatures. The heating time was 5 minutes. Ripening conditions for generating the fluorescents are a ripening temperature of 25° C. and a ripening time of 24 hours. FIG. 4 shows the relationship between the intensity and spectrum of each of the light waves emitted by the generated fluorescents excited by a light wave having a wavelength of 400 nm. The graphs [show] the cases where the heating temperatures are 160° C., 200° C., 240° C., and 280° C., respectively.

The vertical axis of the graph of FIG. 4 represents fluorescence intensity and the horizontal axis represents wavelength. It is understood from this graph that the maximum value of the fluorescence wavelength can be controlled within the range of 620 to 680 nm by changing the heating temperature. The quantum yields of the fluorescents shown in the respective graphs in FIG. 4 are shown in Table 2.

TABLE 2

| Heating Temperature (° C.) | Quantum Yield (%) |
|---|---|
| 160 | 10.1 |
| 200 | 14.5 |
| 240 | 12.2 |
| 280 | 10.2 |

(Excitation Wavelength)

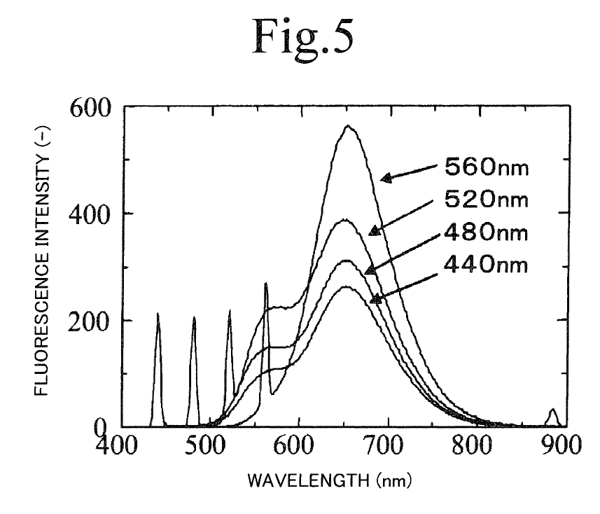

FIG. 5 shows [the results of] irradiating a fluorescent with excitation light having a plurality of wavelengths and [shows] a spectrum of a light wave emitted by [the excitation light]. The graphs [show] the cases where the wavelengths of the excitation light are 440 nm, 480 nm, 520 nm and 560 nm, respectively. The vertical axis of the graph of FIG. 5 represents fluorescence intensity and the horizontal axis represents wavelength. This graph shows fluorescence in which the maximum value of the light wave emitted from the fluorescent is reduced when the wavelengths of the excitation light are long.

(Average Particle Diameter)

The average particle diameters of the products of FIG. 2 of Example 1 were obtained and shown in Table 3. Table 3 also shows the composition ratio among the products of FIG. 2.

TABLE 3

| Heating Time | Composition Ratio | Average Particle |
|---|---|---|
| (seconds) | among Products (Cu:In:S) | Diameter (nm) |
| 3 | 0.8:0.9:2.0 | 3.4 |
| 10 | 0.8:1.0:2.0 | 3.7 |
| 20 | 1.0:1.0:2.0 | 4.0 |
| 600 | 1.1:1.2:2.0 | 4.2 |

(Composition of the Raw Material)

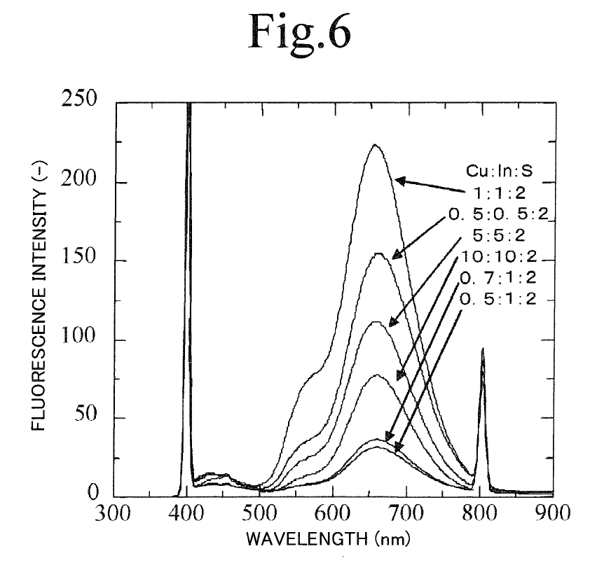

FIG. 6 shows the results of generating fluorescents on the basis of a plurality of raw material compositions. The fluorescents were generated by ripening them for 24 hours at a temperature of 25° C. and heating [the reaction solutions] for 10 seconds at a heating temperature of 200° C. FIG. 6 shows the relationship between the intensity and spectrum of a light wave emitted by each of the generated fluorescent. In each graph the composition molar ratio of copper (Cu) to indium (In) to sulfur (S) in a raw material solution are 0.5:0.5:2.0, 1:1:2, 5:5:2, 10:10:2, 0.7:1:2, and 0.5:1:2.

(Structure)

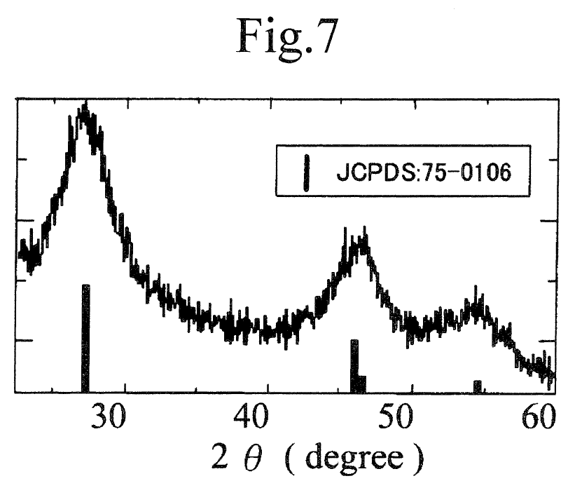

The products of Example 1 were subjected to X-ray diffraction (XRD) measurement, and the results of [the measurement] are shown in the chart of FIG. 7. FIG. 7 [shows] the results of a product [synthesized] at a heating temperature of 200° C. for a heating time of 10 seconds. The black lines drawn perpendicular to the horizontal axis (X-axis) of the chart of FIG. 7 each represents a diffraction line of bulk CuInS₂ (according to the JCPDS database). As is clear from this chart, the product shows basically a chalcopyrite-type structure.

For the product synthesized at a heating temperature of 200° C. for a heating time of 10 seconds, the composition ratio, average particle, and quantum yield of the product are shown in Table 4 by using various raw material composition ratios.

TABLE 4

| | | Average | |
|---|---|---|---|
| Raw Material | | Outer | |
| Composition Ratio | Composition Ratio | Diameter | Quantum |
| (Cu:In:S) | in Products (Cu:In:S) | (nm) | yield (%) |
| 0.5:1.0:2.0 | 0.25:1.0:2.0 | 3.3 | 6.0 |
| 0.7:1.0:2.0 | 0.4:1.0:2.0 | 3.5 | 6.2 |
| 1.0:1.0:2.0 | 0.8:1.0:2.0 | 3.7 | 14.5 |
| 1.5:1.0:2.0 | 1.2:1.0:2.0 | 3.7 | 6.0 |

### Example 2

Here, Example 2 for producing the fluorescent of the present invention will now be described. Reaction solutions were all prepared under argon atmosphere using argon gas. Copper iodide and indium iodide were dissolved at a concentration of 0.017 mol/L in a mixed solution of octadecene and oleylamine which is a complexing agent, to obtain a solution A. The mixing ratio is X (%)=100×oleylamine/(octadecene+oleylamine), where X=100%, 50% and 10%.

Thioacetamide was dissolved at a concentration of 0.034 mol/L in trioctyl phosphine to obtain a solution C. A reaction solution with a mixture of 18 mL of the solution A and 18 mL of the solution C was ripened for 24 hours at a temperature of 25° C., and then heated for 3 seconds to 10 minutes at temperatures of 160° C., 200° C., and 240° C. Note that heating for 3 seconds to 2 minutes was performed using a microreactor having an inner diameter of 200 μm. Thus obtained products were diluted with toluene, and absorbency/fluorescence spectrum [of each product] was measured.

(Fluorescence)

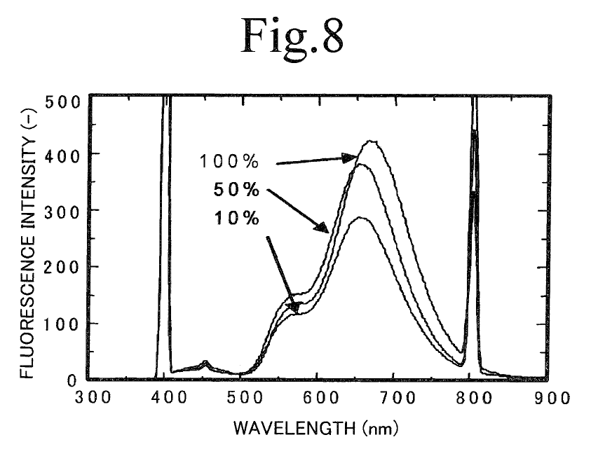

The graph of FIG. 8 shows the results of generating fluorescents by heating them for 5 minutes at a temperature of 200° C. based on a plurality of charge compositions. [FIG. 8] shows the relationship between the intensity and spectrum of each of the light waves emitted by the generated fluorescents. The vertical axis of the graph represents fluorescence intensity and the horizontal axis represents wavelength. The fluorescence intensity was changed by the concentration of oleylamine. Table 5 shows quantum yields of the fluorescents shown in the respective graphs in FIG. 8.

TABLE 5

| Oleylamine Concentration (%) | Quantum Yield (%) |
|---|---|
| 100 | 14.5 |
| 50 | 10.2 |
| 10 | 6.1 |

### Example 3

### Effects of Addition of Gallium

Here, Example 3 for producing the fluorescent of the present invention will now be described. Reaction solutions were all prepared using argon gas under argon atmosphere. Gallium iodide, copper iodide, and indium iodide were dissolved in oleylamine which is a complexing agent, to obtain a solution A. Note that copper iodide was dissolved at a concentration of 0.017 mol/L. Furthermore, gallium iodide and indium iodide were mixed at a mixing ratio of 1−X:X, where X=0, 0.2, 0.4, 0.6, 0.8 and 1.0, so that [the concentration of] the both becomes 0.017 mol/L.

Thioacetamide was dissolved at a concentration of 0.034 mol/L in trioctyl phosphine to obtain a solution C. A reaction solution with a mixture of 18 mL of the solution A and 18 mL of the solution C was ripened for 24 hours at a temperature of 25° C., and then heated for 3 seconds to 10 minutes at temperatures of 160° C., 200° C., and 240° C. Note that heating for 3 seconds to 2 minutes was performed using a microreactor having an inner diameter of 200 μm. Thus obtained products were diluted with toluene, and absorbency/fluorescence spectrum [of each product] was measured.

(Fluorescence)

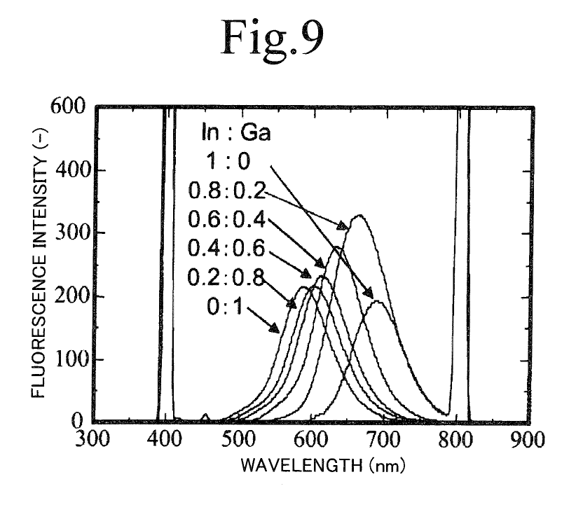

The graph of FIG. 9 shows the results of generating fluorescents by heating [the reaction solutions] for 5 minutes based on a plurality of charge compositions. FIG. 9 shows the results of heating and reacting [the reaction solutions] at a temperature of 200° C. [FIG. 9] shows the relationship between the intensity and spectrum of each of the light waves emitted by the generated fluorescents. The vertical axis of the graph represents fluorescence intensity and the horizontal axis represents wavelength.

(Absorbency)

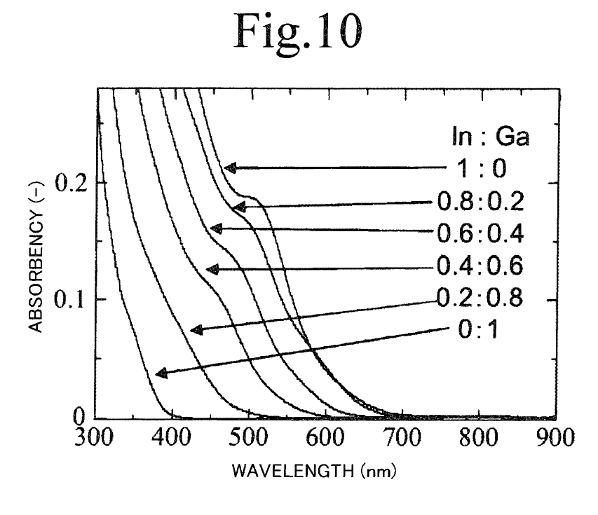

FIG. 10 shows absorbencies each showing the amount of excitation light absorbed by each of the fluorescents shown in the graphs in FIG. 9.

(Effects of Addition of Gallium, Tuning)

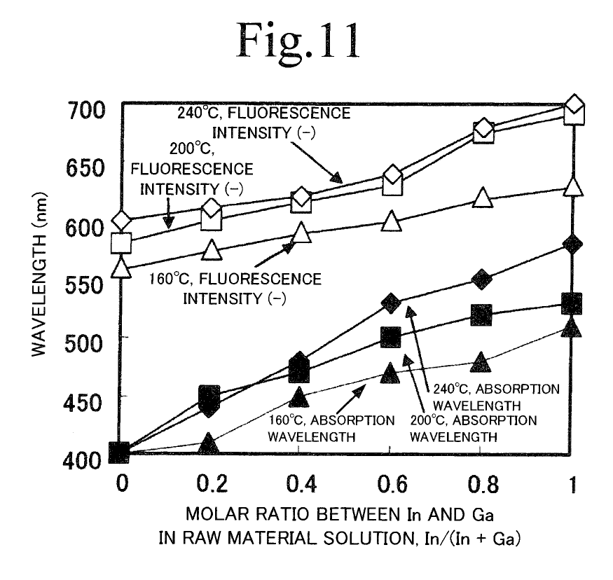

FIG. 11 shows the maximum values of absorption wavelengths and the maximum values of fluorescence wavelengths relative to the molar composition ratio between indium and gallium in the reaction solution, for each of the spectra obtained when the reaction solutions are heated at temperatures of 160° C., 200° C. and 240° C. to generate a fluorescent. The [obtained] products are solid solution-type compounds of CuInS₂ and CuGaS₂. The lattice mismatch ratio between CuInS₂ and CuGaS₂ is approximately 3.3% in the ratios of a axes and approximately 5.2% in the ratios of c axes.

As shown in this figure, the maximum values of absorption wavelengths and the fluorescence wavelengths can be controlled by the molar ratio between indium (In) and gallium (Ga) and the heating temperatures. Also, it is understood that [the maximum values of absorption wavelengths and the fluorescence wavelengths] can be controlled the range of 550 to 700 nm by the molar ratio between indium (In) and gallium (Ga) and the heating temperatures.

(Effects of Addition of Gallium, Quantum Yield)

Table 6 shows quantum yields, each of which represents a ratio of photons emitted by fluorescence to the number of photons of excitation light absorbed by each of the fluorescents shown in FIG. 11.

TABLE 6

| Heating Temperature | Composition Ratio | |
|---|---|---|
| (° C.) | In/(In + Ga) | Quantum Yield (%) |
| 160 | 0 | 6.0 |
| | 0.2 | 6.1 |
| | 0.4 | 10.3 |
| | 0.6 | 10.5 |
| | 0.8 | 11.2 |
| | 1.0 | 10.2 |
| 200 | 0 | 6.2 |
| | 0.2 | 6.5 |
| | 0.4 | 10.4 |
| | 0.6 | 11.2 |
| | 0.8 | 13.2 |
| | 1.0 | 14.5 |
| 240 | 0 | 6.1 |
| | 0.2 | 6.1 |
| | 0.4 | 10.1 |
| | 0.6 | 10.8 |
| | 0.8 | 11.2 |
| | 1.0 | 12.2 |

### Example 4

### Effects of Addition of Silver

Here, Example 4 for producing the fluorescent of the present invention will now be described. Reaction solutions were all prepared under argon atmosphere using argon gas. Silver iodide, copper iodide, and indium iodide were dissolved in oleylamine which is a complexing agent, to obtain a solution A. Note that indium iodide was dissolved at a concentration of 0.017 mol/L. Silver iodide and copper iodide were mixed at a mixing ratio of 1−X:X, where X=0, 0.2, 0.5 and 1.0, so that [the concentration of] the both becomes 0.017 mol/L.

Thioacetamide was dissolved at a concentration of 0.034 mol/L in trioctyl phosphine to obtain a solution C. A reaction solution with a mixture of 18 mL of the solution A and 18 mL of the solution C was ripened for 24 hours at a ripening temperature of 25° C., and then heated for 3 seconds to 10 minutes at temperatures of 160° C., 200° C., and 240° C. Note that heating for 3 seconds to 2 minutes was performed using a microreactor having an inner diameter of 200 m. Thus obtained products were diluted with toluene, and absorbency/fluorescence spectrum [of each product] was measured.

(Fluorescence)

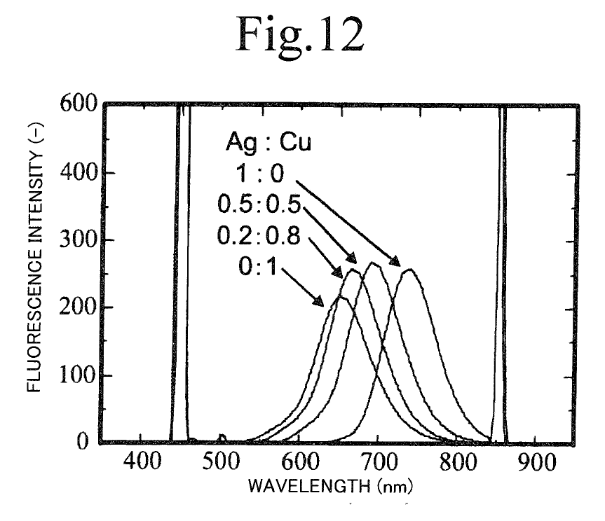

The graph of FIG. 12 shows the results of generating fluorescents by heating them for 5 minutes at a temperature of 200° C. based on a plurality of charge compositions. [FIG. 12] shows the relationship between the intensity and spectrum of each of the light waves emitted by the generated fluorescents. The vertical axis of the graph represents fluorescence intensity and the horizontal axis represents wavelength. The maximum values of fluorescence wavelengths can be controlled within the range of 650 to 750 nm according to the molar ratio between Ag and Cu in the charge compositions.

Note that the [obtained] products are solid solution-type compounds of CuInS₂ and AgInS₂. The lattice mismatch ratio between CuInS₂ and AgInS₂ is approximately 6.3% in the ratios of a axes and approximately 1.9% in the ratios of c axes. Table 7 shows quantum yields of the fluorescents shown in the graph of FIG. 12.

TABLE 7

| Composition Ratio | Quantum Yield |
|---|---|
| Ag/(Cu + Ag) | (%) |
| 1.0 | 6.3 |
| 0.5 | 8.2 |
| 0.2 | 10.1 |
| 0.0 | 10.2 |

### Example 5

### Solid Solutions of CuInS₂ and ZnS

Here, Example 5 for producing the fluorescent of the present invention will now be described. Reaction solutions were all prepared under argon atmosphere using argon gas. Copper iodide and indium iodide were dissolved at a concentration of 0.017 mol/L in oleylamine which is a complexing agent, to obtain a solution A. A trioctyl phosphine solution in which zinc diethyldithiocarbamate is dissolved at a concentration of 0.017 mol/L was prepared as a solution B.

Thioacetamide was dissolved at a concentration of 0.034 mol/L in trioctyl phosphine to obtain a solution C. A solution with a mixture of 18 mL of the solution A and 18 mL of the solution C was mixed with the solution B so that the mixing ratio of copper (Cu) to zinc (Zn) becomes Cu:Zn=1:2, 1:1, 1.0:0.5, and 1.0:0.2, whereby [a reaction solution] was prepared. The reaction solution was ripened and thereafter heated for 3 seconds to 10 minutes at temperatures of 160° C., 200° C. and 240° C. Note that heating for 3 seconds to 2 minutes was performed using a microreactor having an inner diameter of 200 μm. Thus obtained products were diluted with toluene, and absorbency/fluorescence spectrum [of each product] was measured.

(Fluorescence)

Table 8 shows the results of generating fluorescents by heating them for 5 minutes at a temperature of 200° C. based on a plurality of charge compositions. [Table 8] also shows the results of Patent Document 2 for comparison. It was possible to control the maximum values of fluorescence wavelengths within the range of 650 to 750 nm. Table 8 shows quantum yields. Note that [the obtained] products are solid solution-type compounds of CuInS₂ and ZnS. The lattice mismatch ratio between CuInS₂ and ZnS is approximately 2.2%.

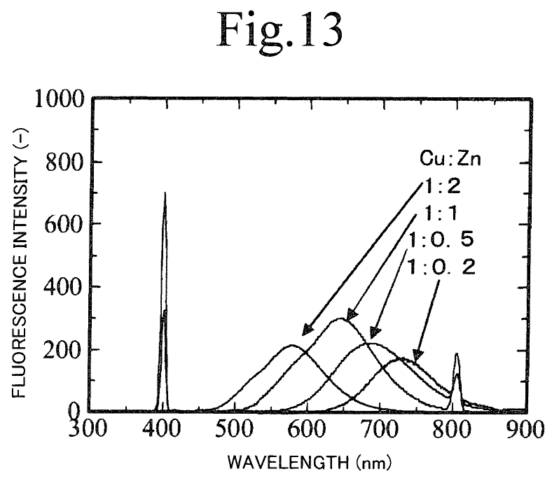

The graph of FIG. 13 shows the results of the measurement on the fluorescents of Table 8. [FIG. 13] shows the relationship between the intensity and spectrum of each of the light waves emitted by the generated fluorescents. The vertical axis of the graph represents fluorescence intensity and the horizontal axis represents wavelength.

TABLE 8

| | | | Fluorescence | Quantum |
|---|---|---|---|---|
| | | | Wavelength | Yield of |
| | Fluorescence | | of Patent | Patent |
| | Wavelength | Quantum | Document 2 | Document 2 |
| Cu:Zn | (nm) | Yield (%) | (nm) | (%) |
| 1:2 | 575 | 6.2 | 560 | ~0.5 |
| 1:1 | 630 | 10.2 | 630 | 6 |
| 1:0.5 | 680 | 8.2 | 680 | 6 |
| 1:0.2 | 730 | 6.5 | 750 | ~0.1 |

### Example 6

### Solid Solutions of CuInS₂ and ZnS

Here, Example 6 for producing the fluorescent of the present invention will now be described. Reaction solutions were all prepared using argon gas under argon atmosphere. Copper iodide and indium iodide were dissolved at a concentration of 0.017 mol/L in oleylamine which is a complexing agent, to obtain a solution A. Zinc iodide was dissolved at a concentration of 0.034 mol/L in the complexing agent of oleylamine to obtain a solution B. Thioacetamide was dissolved at a concentration of 0.034 mol/L in trioctyl phosphine to obtain a solution C.

A solution with a mixture of 18 mL of the solution A and 18 mL of the solution C was mixed with a solution having a mixture of 18 mL of the solution B and 18 mL of the solution C so that the mixing ratio of copper (Cu) to zinc (Zn) becomes Cu:Zn=1:1, 1:2 and 1:3, whereby [a reaction solution] was prepared. The reaction solution was ripened and thereafter heated for 3 seconds to 10 minutes at heating temperatures of 160° C., 200° C. and 240° C. Note that heating for 3 seconds to 2 minutes was performed using a microreactor having an inner diameter of 200 μm. Thus obtained products were diluted with toluene, and absorbency/fluorescence spectrum [of each product] was measured.

(Fluorescence)

Table 9 shows the results of generating fluorescents by heating them for 5 minutes at a temperature of 200° C. based on a plurality of charge compositions. [Table 8] also shows the results of Patent Document 2 as comparative examples. It was possible to control the maximum values of fluorescence wavelengths within the range of 650 to 750 nm. Table 9 also shows quantum yields of the products. Note that [the obtained] products are solid solution-type compounds of CuInS₂ and ZnS. The lattice mismatch ratio between CuInS₂ and ZnS is approximately 2.2%.

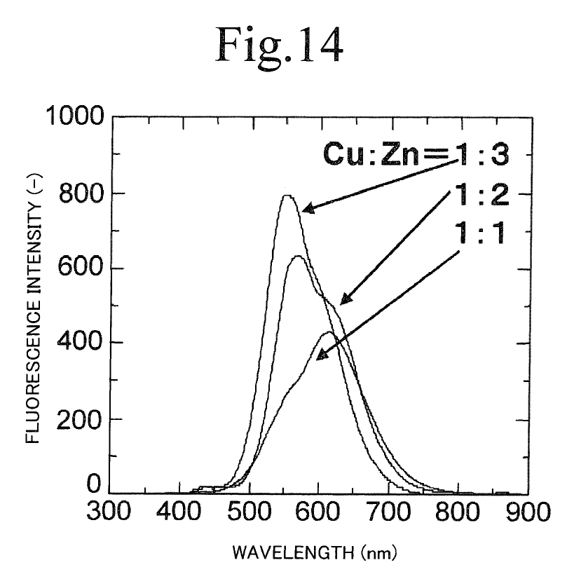

The graph of FIG. 14 shows the results of the measurement on the fluorescents of Table 9, and the relationship between the intensity and spectrum of each of the light waves emitted by the generated fluorescents. It was possible to control the maximum values of fluorescence wavelengths within the range of 540 to 620 nm. The vertical axis of the graph represents fluorescence intensity and the horizontal axis represents wavelength.

TABLE 9

| | | | Fluorescence | Quantum |
|---|---|---|---|---|
| | | | Wavelength | Yield of |
| | Fluorescence | | of Patent | Patent |
| | Wavelength | Quantum | Document 2 | Document 2 |
| Cu:Zn | (nm) | Yield (%) | (nm) | (%) |
| 1:3 | 540 | 26.3 | — | — |
| 1:2 | 560 | 20.0 | 560 | 6.0 |
| 1:1 | 620 | 13.0 | 630 | 6.0 |

### Example 7

### Coating-Type Composition with ZnSe

Example 7 for producing the fluorescent of the present invention will now be described. Reaction solutions were all prepared under argon atmosphere using argon gas. A solution D was prepared by mixing a 20 mL solution in which zinc acetate was dissolved at a concentration of 0.04 mol/L in octadecene in which oleic acid was dissolved at a concentration of 2%, with a 10 mL trioctyl phosphine solution in which selenium was dissolved at a concentration of 0.4 mol/L.

In Example 1 described above, the products obtained by the method described in Example 1 were added to the 30 mL solution D at a concentration of 0.008 mol/L, and heated at a temperature of 100° C. to 300° C., whereby a coating type composite particle was synthesized. Note that the lattice mismatch ratio between CuInS₂ and ZnSe is approximately 2.6%. Table 10 shows the composite ratio (Zn/Cu) and particle diameters of the products.

(Fluorescence)

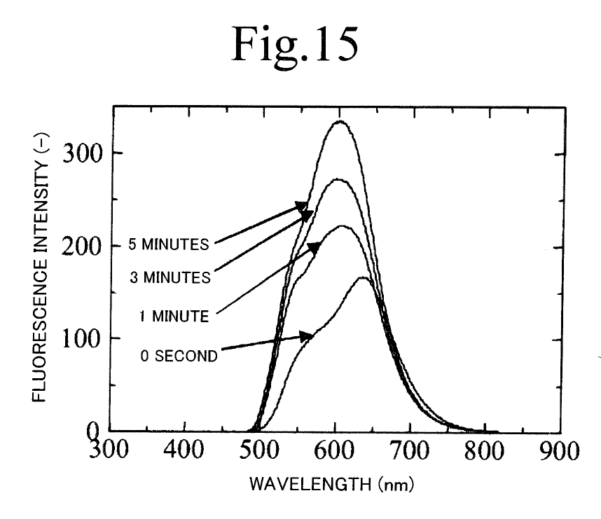

The graph of FIG. 15 shows the results of generating, for a plurality of heating times, fluorescents generated by performing heat treatment on [reaction solutions] at a temperature of 180° C. FIG. 15 shows the relationship between the intensity and spectrum of each of the light waves emitted by the generated fluorescents. The graphs [show] the cases where the heating times are 0 to 5 minutes. Note that heating for 3 seconds to 2 minutes was performed using a microreactor having an inner diameter of 200 μm. The vertical axis of the graph of FIG. 15 represents fluorescence intensity and the horizontal axis represents wavelength.

(Quantum Yield)

Table 10 shows quantum yields, each of which represents a ratio of photons emitted by fluorescence to the number of photons of excitation light absorbed by each of the fluorescents shown in the graphs in FIG. 15. It was possible to increase the quantum yield to 20% or higher by forming a gradient type composite particle structure for CuInS₂ and ZnSe.

TABLE 10

| Heating Time | | Outer Particle | Quantum Yield |
|---|---|---|---|
| (minutes) | Zn/Cu | Diameter (nm) | (%) |
| 0 | 0.0 | 3.2 | 8.2 |
| 1 | 1.5 | 3.9 | 10.1 |
| 3 | 1.6 | 3.9 | 13.5 |
| 5 | 1.6 | 4.1 | 20.6 |

(Mixing Ratio between Cu and Zn in Reaction Solution)

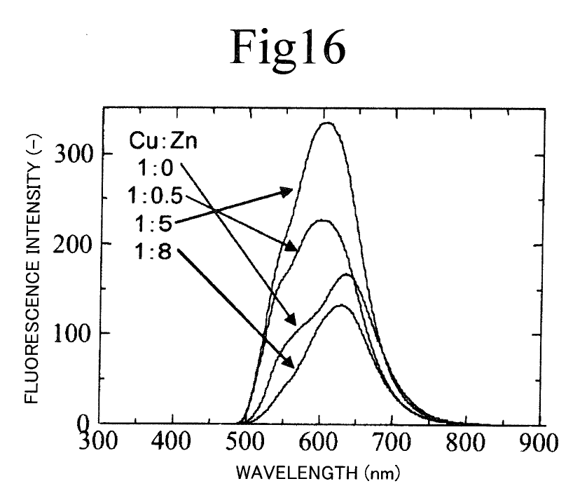

Each of graphs in FIG. 16 shows the relationship between the intensity and spectrum of each of the light waves emitted by the generated fluorescents when there are a plurality of composition ratios between copper (Cu) and zinc (Zn) in a reaction solution. The reaction solution was prepared by adding the products obtained by the method described in Example 1 to the solution D so that the mixing ratio between copper (Cu) and zinc (Zn) becomes Cu:Zn=1.0:0.5, 1:5, and 1:8. The synthesis temperature was 180° C. and the synthesis time was 5 minutes.

### Example 8

### Coating-Type Composition with ZnS

Here, Example 8 for producing the fluorescent of the present invention will now be described. Reaction solutions were all prepared using argon gas under argon atmosphere. A trioctyl phosphine solution in which zinc diethyldithiocarbamate was dissolved at a concentration of 0.04 mol/L was prepared as a solution E. In Example 1 described above, the products obtained by the method described in Example 1 were added to the 30 mL solution E at a concentration of 0.008 mol/L, and heated, whereby a coating type composite particle was synthesized. Note that the lattice mismatch ratio between CuInS₂ and ZnS is approximately 2.2%. Table 11 shows the composite ratio (Zn/Cu) and particle diameters of the products.

(Fluorescence)

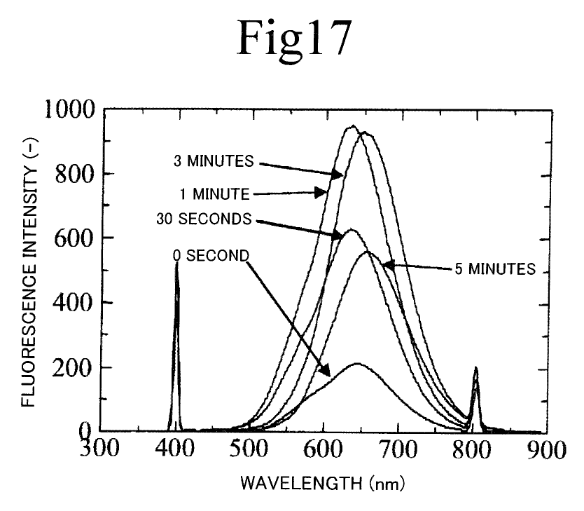

The graph of FIG. 17 shows the results of generating, for a plurality of heating times, fluorescents generated by performing heat treatment on [reaction solutions] at a temperature of 180° C. FIG. 17 shows the relationship between the intensity and spectrum of each of the light waves emitted by the generated fluorescents. The graphs [show] the cases where the heating times are 0 second to 5 minutes. Note that heating for 3 seconds to 60 seconds was performed using a microreactor having an inner diameter of 200 μm. The vertical axis of the graph of FIG. 17 represents fluorescence intensity and the horizontal axis represents wavelength. The fluorescence intensity was increased by the reaction.

(Quantum Yield)

Table 11 shows quantum yields, each of which represents a ratio of photons emitted by fluorescence to the number of photons of excitation light absorbed by each of the fluorescents shown in the graphs in FIG. 17. It was possible to increase the quantum yield to nearly 30% by forming a coating type composite particle structure.

TABLE 11

| Heating Time | | Particle | Quantum Yield |
|---|---|---|---|
| (seconds) | Zn/Cu | Diameter (nm) | (%) |
| 0 | 0 | 3.2 | 8.2 |
| 30 | 1.3 | 3.6 | 20.4 |
| 60 | 1.5 | 3.8 | 27.8 |
| 180 | 1.5 | 3.8 | 15.2 |
| 300 | 1.6 | 4.0 | 11.6 |

(Mixing Ratio Between Cu and Zn in Reaction Solution)

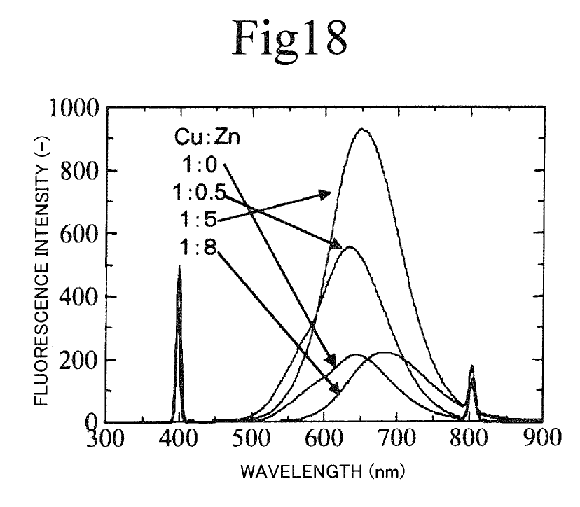

Each of graphs in FIG. 18 shows the relationship between the intensity and spectrum of each of the light waves emitted by the generated fluorescents when there are a plurality of composition ratios between copper (Cu) and zinc (Zn) in a reaction solution. The reaction solution was prepared by adding the products obtained by the method described in Example 1 to the solution D so that the mixing ratio between copper (Cu) and zinc (Zn) becomes Cu:Zn=1.0:0.5, 1:5, and 1:8. The synthesis temperature was 180° C. and the synthesis time was 3 minutes.

### Example 9

### Production of CuInSe₂

Here, Example 9 for producing the fluorescent of the present invention will now be described. Reaction solutions were all prepared under argon atmosphere using argon gas. Copper iodide (I) and indium iodide (III) were dissolved at a concentration of 0.017 mol/L in oleylamine which is a complexing agent, to obtain a solution A. Selenium was dissolved at a concentration of 0.034 mol/L in Trioctylphosphine to obtain a solution D.

A reaction solution with a mixture of 18 mL of the solution A and 18 mL of the solution D was basically ripened for 24 hours at a temperature of 25° C. under argon atmosphere. Thereafter, the reaction solution was heated and reacted for 10 minutes at a temperature of 200° C. to 280° C. Thus obtained products were diluted with toluene, and absorbency/fluorescence spectrum [of each product] was measured.

(Heating Effects)

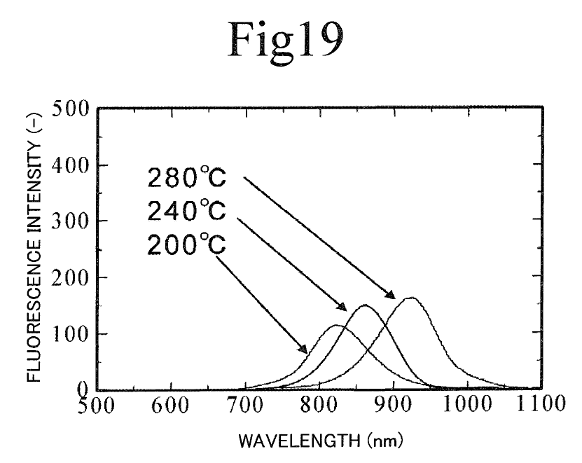

The graph of FIG. 19 shows the results of generating fluorescents by heating, at a plurality of heating temperatures, the reaction solution that was ripened for 24 hours at a temperature of 25° C. under argon atmosphere. The graphs [show] the cases where the heating temperatures are 200° C., 240° C., and 280° C., respectively. The vertical axis of the graph of FIG. 19 represents fluorescence intensity and the horizontal axis represents wavelength. It is understood from this graph that the maximum value of the fluorescence wavelength can be controlled within the range of 820 to 930 nm by changing the heating temperature.

Table 12 shows the quantum yields, outer particle diameters and average diameter of the fluorescents showing the graphs in FIG. 19. It was possible to obtain a fluorescent having a quantum yield of 3.2% when [the reaction solution] was heated at a heating temperature of 240° C., and it was possible to obtain a fluorescent having a quantum yield of at least 5% when [the reaction solution] was heated at a heating temperature of at least 240° C.

TABLE 12

| | Average Outer | |
|---|---|---|
| Temperature (° C.) | Diameter (nm) | Quantum Yield (%) |
| 200 | 3.5 | 3.2 |
| 240 | 3.8 | 5.5 |
| 280 | 4.1 | 6.0 |

1. (canceled)

2. A fluorescent, comprising a first compound composed of each one type of element from elements of I, III and VI group and having a chalcopyrite structure, wherein an outer diameter of a particle composed of the first compound is 0.5 to 20.0 nm, and a fluorescent quantum yield of the particle, at which is excited by excitation light and thereby emitting a light wave, is at least 3.0% but not more than 20.0% at room temperature, the particle is produced by preheating a reaction solution for generating the first compound at a predetermined temperature lower than a heating temperature described hereinafter for a predetermined amount of time to form a cluster, and thereafter heating and reacting the reaction solution at the heating temperature for a predetermined amount of time for heating.

3. The fluorescent according to claim 2, wherein a composition ratio among the I, III and VI group elements composing the first compound is A:B:2, with A being 0.2 to 1.2 and B being 0.8 to 1.2.

4. The fluorescent according to claim 2, wherein the first compound is produced from raw materials of the I, III and VI group elements at a composition ratio of A:B:2, with A being 0.5 to 10.0 and B being 0.5 to 10.0.

5. The fluorescent according to claim 2, wherein the I group element of the first compound is copper (Cu) or mercury (Ag), the III group element of the same is indium (In) or gallium (Ga), and the VI group element of the same is sulfur (S) or selenium (Se).

6. The fluorescent according to claim 2, which is a composite particle obtained by coating the particle with a second compound composed of elements of II and VI group, and a lattice mismatch ratio between the first compound and the second compound is not more than 10%.

7. The fluorescent according to claim 6, wherein a fluorescent quantum yield of the composite particle, at which the composite particle is excited by excitation light and thereby emitting a light wave, is at least 6.0% but not more than 30.0%.

8. The fluorescent according to claim 6, wherein the composite particle is produced by mixing a second reaction solution for generating the second compound with the particle and heating [the mixture] at a predetermined second heating temperature for a second predetermined amount of time for heating so as to obtain an outer diameter of 1 to 20.0 nm.

9. The fluorescent according to claim 6, wherein a composition ratio of a raw material of the II group element of the second compound, a raw material of the I group element of the first compound, a raw material of the III group element of the first compound, a raw material of the VI group element of the second compound, and a raw material of the VI group element of the first compound is A:B:C:D:2, with A being 0.5 to 10.0, B being 0.5 to 10.0, C being 0.5 to 10.0, and D being 0.5 to 10.0.

10. The fluorescent according to claim 6, wherein the second compound is zinc sulfide (ZnS) or zinc selenide (ZnSe).

11. The fluorescent according to claim 2, which is a solid solution-type composite compound comprising:
(a) the first compound; and
(b) a second compound which is a compound composed of I, III and VI group elements, the compound being other than the first compound, or a compound composed of II and VI group elements,
wherein an outer diameter of a particle composed of the composite compound is 0.5 to 20.0 nm.

12. The fluorescent according to claim 11, wherein the particle is produced by preheating a reaction solution for generating the composite compound at a temperature lower than a heating temperature described hereinafter for a predetermined amount of time to form a cluster, and thereafter heating and reacting the reaction solution at the heating temperature for a predetermined amount of time for heating.

13. The fluorescent according to claim 12, wherein the composite compound is produced from raw materials at a composition ratio of the III group element of the first compound and the III group element of the second compound composed of the elements of I, III and VI group elements being X:1−X, with X being 0.01 to 0.99.

14. The fluorescent according to claim 12, wherein the composite compound is produced from raw materials at a composition ratio of the I group element of the first compound and of the I group element of the second compound composed of I, III and VI group elements being X:1−X, with X being 0.01 to 0.99.

15. The fluorescent according to claim 12, wherein the composite compound is produced from raw materials at a composition ratio of the I group element of the first compound and the II group element of the second compound composed of the II and VI group elements being X:1−X, with X being 0.01 to 0.99.

16. The fluorescent according to claim 11, wherein a fluorescent quantum yield of the composite compound, at which the composite compound is excited by excitation light and thereby emitting a light wave, is at least 6.0% but not more than 30%.

17. The fluorescent according to claim 11, wherein a lattice mismatch ratio between a lattice constant of the first compound of the composite compound and a lattice constant of the second compound of the composite compound is not more than 10%.

18. The fluorescent according to claim 11, wherein the first compound is CuInS₂, and the second compound is CuGaS₂ or AgInS₂.

19. The fluorescent according to claim 11, wherein the first compound is CuInS₂, and the second compound is ZnS or ZnSe.

20. The fluorescent according to claim 2, wherein the fluorescence to be emitted has a wavelength of 500 to 950 nm.

21. A method for producing a fluorescent, comprising the steps of: mixing a first solution, which is prepared by dissolving and mixing a raw material salt of a plurality of types of elements composing a compound having a chalcopyrite structure in a solution added with a complexing agent of the plurality of types of elements, with a second solution in which chalcogenite is dissolved; pretreating the mixed solution under predetermined pretreatment conditions; and heat-treating the mixed solution under predetermined heat conditions.

22. The method for producing a fluorescent according to claim 21, wherein after the mixed solution is pretreated under the predetermined pretreatment conditions, the mixed solution is heat-treated under the predetermined heat conditions by using a microreactor having a flow channel of 50 μm to 5 mm.

23. The method for producing a fluorescent according to claim 21, wherein the predetermined pretreatment conditions comprise a temperature of 0° C. to 100° C. and a duration of one second to not more than 30 days, and in the pretreatment a cluster is formed by preheating a mixed reaction solution composed of the first solution and the second solution at a temperature lower than the heating temperature.

24. The method for producing a fluorescent according to claim 21, wherein the first solution is a solution which is prepared by mixing (A) a solution, which is prepared by dissolving a salt of copper (I) or silver (I) of a I group element in a solution added with a complexing agent coordinating the I group element, with (B) a solution, which is prepared by dissolving a salt of indium (III) or gallium (III) of a III group element in a solution added with a complexing agent coordinating the III group element.

25. The method for producing a fluorescent according to claim 24, wherein a fluorescent is produced from raw materials of the I group element and of the III group element and chalcogen of the chalcogenite at a composition ratio of A:B:2, with A being 0.5 to 10.0 and B being 0.5 to 10.0.

26. The method for producing a fluorescent according to claim 21, wherein a compound which generates chalcogen of the chalcogenite to be dissolved in the second solution is one compound selected from among thioacetamide, hydrogen sulfide, thiourea, trioctylphosphine sulfide, and sulfur.
